(19) United States
(12) Patent Application Publication
(10) Pub. No.: US 2022/0009565 A1
(43) Pub. Date: Jan. 13, 2022

(54) SYSTEM FOR AERODYNAMICALLY IMPROVING A LAND VEHICLE, IN PARTICULAR A TRUCK OR THE LIKE

(71) Applicant: EGHI, Sexten (IT)

(72) Inventor: Christoph EGARTER, Sexten (IT)

(73) Assignee: EGHI, Sexten (IT)

(21) Appl. No.: 17/297,552

(22) PCT Filed: Jan. 13, 2020
(86) PCT No.: PCT/EP2020/050659

§ 371 Date: May 27, 2021

(30) Foreign Application Priority Data
Jan. 14, 2019 (IT) 1020190000000543

(51) Int. Cl. B62D 35/00

(52) U.S. Cl. CPC B62D 35/001

(57) ABSTRACT

A system for aerodynamically improving a land vehicle comprising an outer surface of the vehicle and a rear surface in the direction of travel, a deflector, having an inclination with respect to the front surface, and a series of vortex generators which are arranged on the surfaces. The rear surface, deflector, is inclined to the centre of the vehicle by between 5° to 30° with respect to the outer surface of the vehicle, and the vortex generators are arranged on the outer surface at a maximum distance of 250 mm from the change in inclination between the outer surface of the vehicle and the rear surface, wherein the vortex generators, have an inclination (β) in relation to the vehicle longitudinal axis of between 2° to 50° and the vortex generators protrude by between 1 cm to 15 cm in relation to the adjacent surfaces.

### BACKGROUND OF THE INVENTION

The present invention relates to a system for aerodynamic improvement of a ground vehicle, in particular for a truck or the like.

The aerodynamic characteristics of a vehicle are among the most important characteristics for fuel consumption. In particular for vehicles, covering a large number of kilometres, even a small amount of optimization can bring great advantages. Saving fuel means lowering costs. In addition, fuel reduction leads to a lower environmental impact and may therefore lead to tax advantages.

A large number of systems to improve the air flow and thus the aerodynamic characteristics are known already.

U.S. Pat. No. 8,851,554 describes an aerodynamic resistance reduction composition that can be mounted on a moving vehicle or other object. The system described comprises air inducts and at least one mesh sleeve of flexible material which moves from an active position to a second inactive position and vice versa. The shell is also designed to provide at least one outer surface, designed to reduce the effects of vortex drag. The system described can also be combined with ducts in order to direct the air flow into the sleeve. The flexible elements cause problems during use because they cause instability to the vehicle. In addition, their movements are difficult to predict and/or the aerodynamic effects may vary due to the movements and the material is subject to damage and therefore requires continuous maintenance.

From U.S. Pat. No. 8,770,649, a system for reducing the aerodynamic effects of of air resistance from drag and for reducing the effects of cross winds for ground vehicles is known. This system described contains vortex generators to create small vortexes. These small air vortexes described create a long drag. Each of the vortex generators (vortex) includes one or more air flow ducts to force the air flow through these ducts. There are a number of problems with the system described, in particular the ducts may get dirty or blocked with debris and they are complicated to assemble, which is not useful for an everyday use on ground vehicles. Furthermore, the system also needs the so-called tunnel effect in order for vortex generators to be effective.

The publication GB 250 83 57 describes a removable device to increase the aerodynamic efficiency of a ground vehicle. The device described includes elements, extending the lateral body on three sides of the ground vehicle in accordance with the shape of the ground vehicle. Vortex generators are capable to be attached to these extensions. The vortex generators adjacent surfaces The device described does not change the outer body in order to change the air flow, or in particular to change the boundary layer of the air flow. The described vortex generators do not protrude from the body to affect the air flow and thus have a different technical effect.

U.S. Pat. No. 6,959,958 describes a method and a device for reducing the air resistance on vehicle bodies while travelling on motorways and the like. These trucks can, for example, contain elements to improve the aerodynamic effects at the rear of the vehicle. Furthermore, the system described includes vortex generators arranged on the truck or on the vehicle trailer. The system described does not describe any synergy effects between the vortex generators and the structure at the rear of the truck or ground vehicle. The system described only tries to change the lateral airflow. There is no targeted flow guidance of the generated air vortexes in the direction of the vehicle centre to generate the synergy effect.

U.S. Pat. No. 7,255,387 describes improved devices for reducing aerodynamic effects to improve the vehicle performance and to reduce fuel consumption. The configuration described includes multiple surfaces disposed on the exterior surface of a vehicle. These surfaces are dimensioned according to the thickness of the vehicle shell and their length is at least five times the thickness of the vehicle shell. Any of these surfaces can create vortexes. The vortex generators described in the publication U.S. Pat. No. 7,255,387 only serve to change the lateral air flow to the vehicle and to facilitate stable lane keeping. They are not used to reduce the rear base area of the vehicle, on which the negative pressure is applied and thus the driving resistance is generated. In this way, the publication does not reduce air resistance, but creates greater resistance, and the consumption increases.

U.S. Pat. No. 7,008,004 describes a device for modifying the air flow downstream of a vehicle by means of elements which are arranged at the end of the ground vehicle, for example trucks, which form the rear of the truck and generate an air flow which is essentially parallel to the longitudinal axis of the vehicle. In this publication, the rear of the vehicle is extended without lateral vortex generators.

US 2017274941 describes a system for modifying the air flow, with vortex generators mounted on the inclined surfaces. No combination effect is described between the position of the vortex generators, the inclination of the surfaces and the air layers, that are not influenced by the vortex generators.

US 2011210578 also teaches a system for modifying the air flow. Also here, no combination effect is described between the position of the vortex generators, the body inclination of the surfaces and the air layers that are not influenced by the vortex generators.

### SUMMARY OF THE INVENTION

The object of the present invention is to provide a system for ground vehicles, in particular trucks or the like, which improves the aerodynamic properties of the vehicle by reducing fuel and/or energy consumption, or a kit for modifying a ground vehicle to improve the aerodynamic properties.

This is achieved by a system for ground vehicles, in particular trucks, buses, trailers and semi-trailers according to the claims.

The system according to the invention for ground vehicles, in particular trucks, buses, trailers and semi-trailers, comprises an outer surface of the vehicle and at least one rear surface, a deflector, arranged in the direction of movement with an body inclination relative to the front surface and a series of vortex generators on the surfaces, characterized in that the rear surface, the deflector, is inclined between 5° and 30° to the centre of the vehicle compared to the front outer surface of the vehicle, this change in body inclination is denoted by α and arranged to the vortex generators on the outer surface to α with a maximum distance of 250 mm from the change in body inclination. The vortex generators or at least part of them are shaped with an angle β relative to the longitudinal axis of the vehicle between 2° and 50° is provided between the surface of the outer front side wall of the vehicle and the rear surface, the deflector, the outer front side body surface of the vehicle and/or the rear deflector surface and. the vortex generators or parts of these vortex generators, and the vortex generators protrude between 1 cm and 15 cm in relation to the adjacent surfaces.

The vortex generators may be arranged converging (extending to each another) and/or diverging (away from each other) or parallel to each another. The protrusion of the vortex generators between 1 cm and 15 cm from the adjacent surfaces enables them to change the air flow and in particular the boundary layer of the air flow. Furthermore, this modification is particularly advantageous because it is combined with the deflectors or the body inclination (angle of attack) of the outer surface of the body.

The surprising combined effect of the two elements, the deflectors and the vortex generators, allows the deflectors a higher body inclination without air flow separation. In this way, a higher reduction of rear basal face of the vehicle can be achieved compared to a known system.

All of this leads to improved aerodynamic properties for the ground vehicle as the air flows downstream of the vehicle are controlled by improving its aerodynamic conditions. The system described here may also be sold and installed as a conversion kit, attachment kit, where body elements are added to the rear of the ground vehicle, for example a truck, and therefore convert an existing vehicle in this way. These surfaces/baffles/deflectors are to be installed at an angle of body inclination α (alpha) between 5° and 30° to the centre of the vehicle. The vortex generators can already be positioned on this additional surface attached to the outer surfaces of the ground vehicle close to the additional surfaces with a maximum distance of 250 mm. Advantageously, the deflectors may be demountable. In this way, quick demounting when not in use and/or replacement is possible.

In a preferred embodiment, the inclined deflector may can be formed from both a rigid material or from a flexible material. In a preferred embodiment, the rear surface of the deflector is a single piece and is co-formed with or integrated with the outer forward surface or integrated in the front ground vehicle structure.

The deflectors are advantageously arranged on at least two sides of the vehicle.

In a further embodiment, the ground vehicle may comprise a tubular or curved cylindrical body, e.g. tank trucks, and therefore the deflecting element may be formed in a curved, circular or part-circular shape. The body inclination of the deflector element is always directed towards the centre of the ground vehicle.

Advantageously, the vortex generators are not all of the same size, but vary in order to better regulate the ambient air flow.

In a preferred embodiment, the deflectors form a trunk/storage space, for example behind a bus for transportation of objects, for example luggage and/or skis or bicycles or other bulky luggage.

According to the invention, the system can be built as a conversion kit/attachment kit to be mounted on existing vehicles.

This attachment kit may consist of several deflection surfaces, mounted to the rear of the truck/bus. In this embodiment, the vortex generators are advantageously arranged or integrated on the deflection surfaces.

In a preferred embodiment, predetermined breaking points are present between the deflection elements and the preceding surfaces in order to reduce the effects of an accident. These predetermined breaking points can be useful to facilitate compliance with safety standards, if required.

Further features and details of a preferred and non-limiting embodiment of a system according to the invention are clearly described below in the detailed description with the aid of the accompanying figures:

### DESCRIPTION OF THE DRAWINGS

FIG. 1 shows a perspective view of a truck with a system according to the invention;

FIG. 2 is a perspective view of a truck with a system according to the invention in a second embodiment;

FIG. 3 is a top view of a truck with a system according to the invention in the first embodiment;

FIG. 4 is a detail of a top view of a truck with a system according to the invention in the first embodiment;

FIG. 5 is a detail of a top view of a truck with a system according to the invention in the second embodiment;

FIG. 6 is a perspective side view of a truck with a system according to the invention in a further embodiment;

FIG. 7A is a graphic representation of the air behaviour with baffles/deflectors only.

FIG. 7B is a graphic representation of the air behaviour with deflectors/baffles in combination with vortex generators.

FIG. 8 is a perspective rear view of a truck with a system according to the invention in a further embodiment in an exploded view;

FIGS. 9 and 10 are a perspective view of trucks with a system according to the invention in further embodiments;

FIG. 11 is a perspective side view of a bus with a system according to the invention, which forms a storage box; and

FIG. 12 is a system according to the invention with various embodiments of the vortex generators.

### DETAILED DESCRIPTION OF THE INVENTION

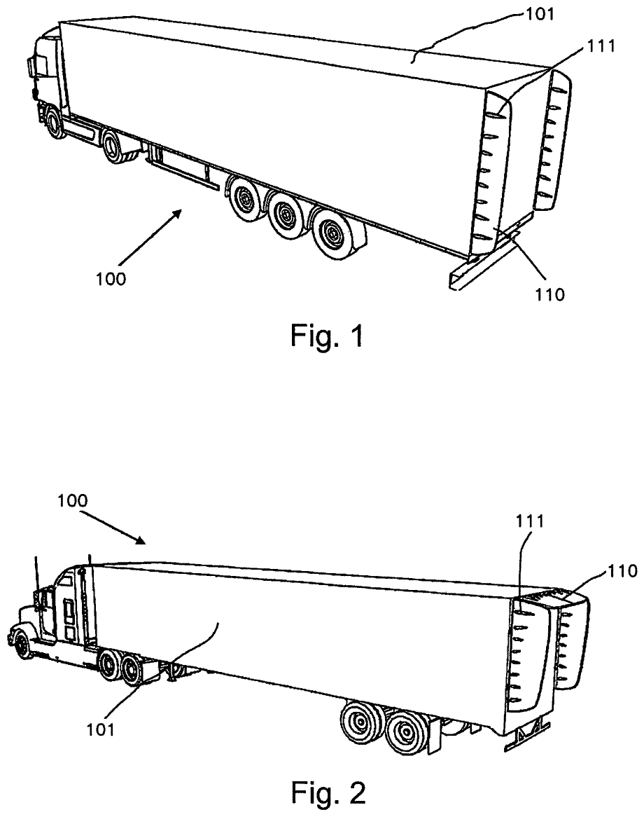

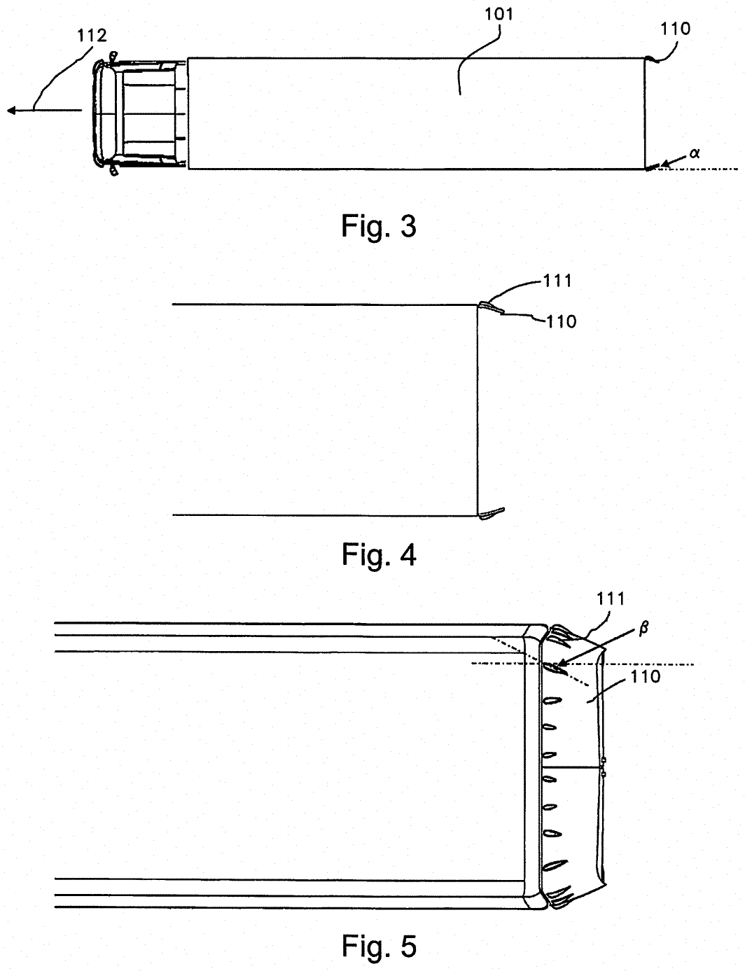

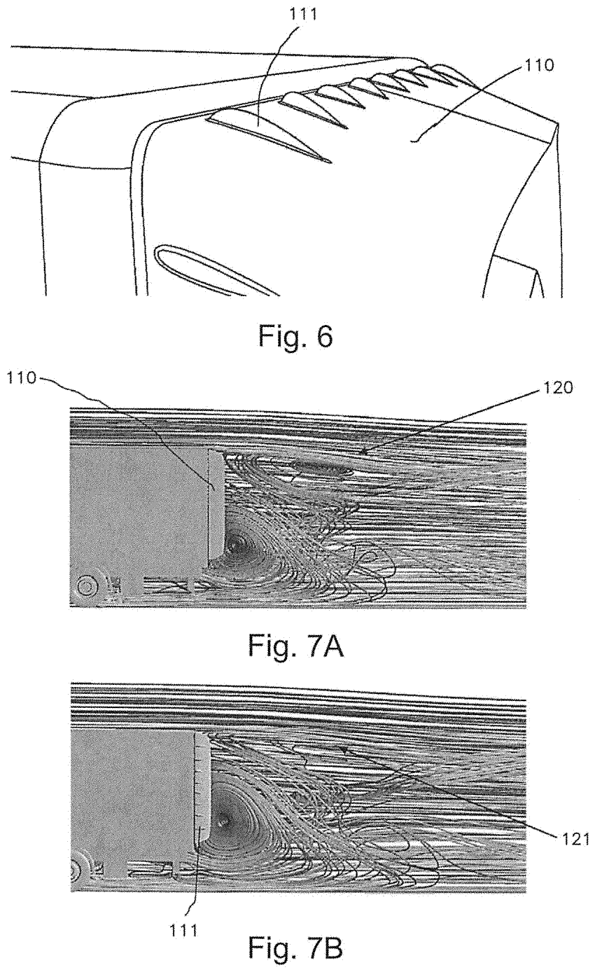

In FIG. 1, a ground vehicle, in particular a truck, is denoted by the reference 100. This ground vehicle 100 has lateral outer side body surfaces 101 which, for example, can form the storage space. During movement of the ground vehicle 100 in the direction 112, air flows onto the outer side body surfaces 101. This air can form drag turbulence or other aerodynamic effects that increase the energy consumption, in particular the fuel consumption of the ground vehicle. The air flow, in particular drag turbulences at the rear of a ground vehicle, in particular on a truck or the like, are very important with regard to the overall aerodynamic behaviour of the vehicle.

These drag turbulences, which form the air behaviour downstream of the vehicle, are mainly caused by the base area of the vehicle. This base area is the rear area of the vehicle

According to the invention, there are deflector surfaces 110 on the rear of the ground vehicle 100, which are connected to the ground vehicle 100 and/or form a single surface with the outer side body surfaces 101 of the truck. The deflectors 110 are inclined towards the centre of the truck, and form a body inclination angle alpha (α) with respect to the outer side body surfaces 101. The deflectors 110 are inclined to the central longitudinal axis of the vehicle at an alpha (α) inclination angle between 5° and 30°. This reduces the base area of the vehicle and thereby reduces the air resistance depending on the rear drag. In a preferred embodiment, the other side body surfaces 101 and the deflector 111 are formed as a single element.

Vortex generators 111 are arranged on the outer surface in an area, and this area starts from 250 mm before the change in body inclination and ends 250 mm after the change in body inclination. These vortex generators 111 or parts of these vortex generators 111 are inclined with respect to the longitudinal axis of the truck. The β-inclination of the vortex generators 111 or parts of these vortex generators 111 may have a preferably curved wing shape between 2° and 50° with respect to the longitudinal axis of the ground vehicle 100.

Furthermore, the vortex generators 111 are designed in a way to protrude between 1 cm and 15 cm from the surrounding surface. In this way, the vortex generators 111 are able to modify the direction of the ambient air flow and in particular the boundary layer in a more effective way.

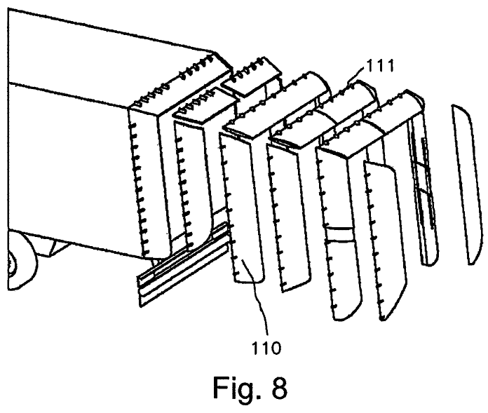

As shown in FIG. 7A, the drag turbulences downstream of the ground vehicle 100, which were only realized with smooth deflectors 110, are nevertheless high turbulence 120, which results in a greater energy consumption of the vehicle, in particular fuel.

FIG. 7B shows the air flow downstream of a ground vehicle 100 with deflectors 110 and vortex generators 111, which are designed according to the invention.

reduced drag The turbulence 121 reduces the fuel consumption of the ground vehicle 100.

FIG. 8 shows a kit for modifying a ground vehicle 100, which can be formed by various form shapes of deflectors 110 on which the vortex generators 111 are arranged.

The deflectors 110 may be detachably connected to the ground vehicle, and predetermined breaking members (predetermined breaking points) for safety reasons in the event of accidents may also be provided.

In a preferred embodiment, the baffles/deflectors forming the rear of the truck can be shaped to absorb shocks or other impacts from ground vehicles in the event of an accident.

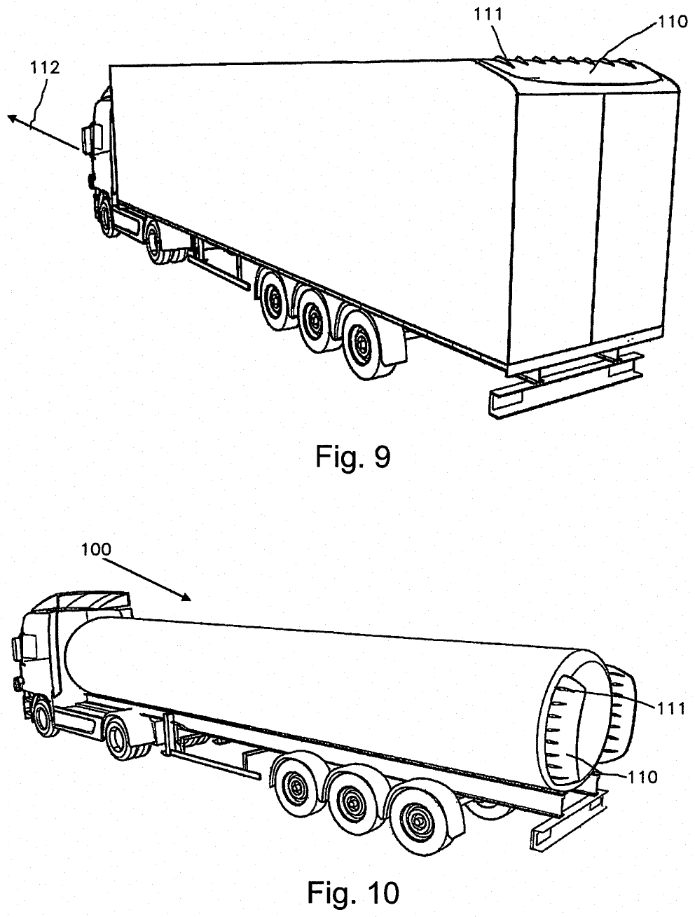

FIG. 9 shows a ground vehicle 100 moving in direction 112 and having a deflector 110 according to the invention at the rear of the ground vehicle, which is integrated into the structure of the ground vehicle and which is arranged in the predefined area of the vortex generators 111 according to the invention.

FIG. 10 shows another ground vehicle with a tubular surface, for example a liquid container truck, and a deflector 110 with the vortex generators 111 according to the invention. Also here, the deflector 110 inclined towards the centre of the vehicle forms an α-inclination angle with respect to the preceding body surface.

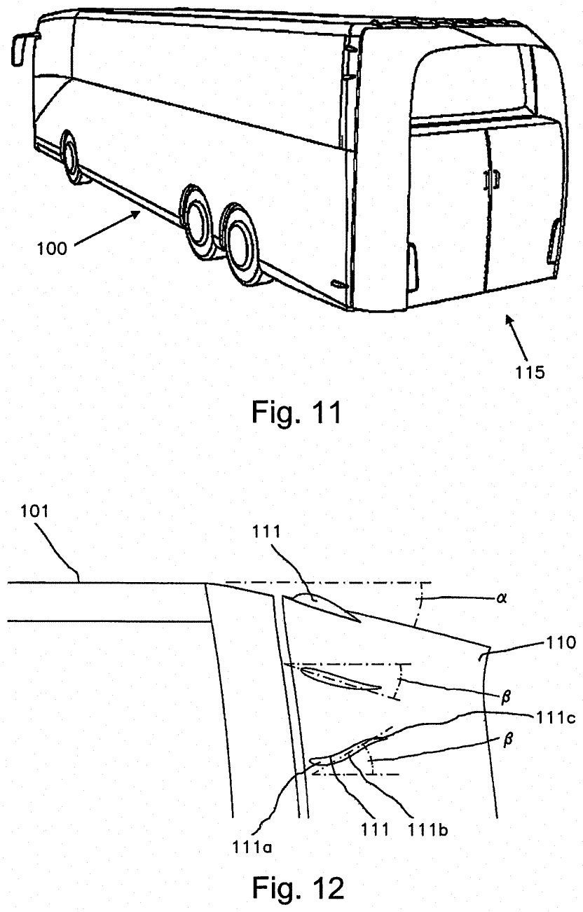

In FIG. 11, the deflectors are designed to create an additional loading zone downstream of the vehicle. For example, the deflectors may be arranged to form a storage box 115 downstream of a ground vehicle 100, such as a bus. This box may be used to store luggage, skis or other bulky items.

In a further embodiment, the ground vehicle may be formed with a tubular or curved cylindrical body and therefore the deflecting element may be formed in a curved, circular or part-circular shape. The inclination of the deflector element is always directed towards the centre of the ground vehicle.

FIG. 12 shows a system according to the invention in which a series of vortex generators 111 are shown, in particular a vortex generator having a first part 111a which is not inclined with respect to the longitudinal axis of the vehicle, the second part 111b has an inclination-β (beta) with respect to the longitudinal axis of the vehicle between 2° and 50° and the last part of the vortex generators 111c has a minimum inclination with respect to the longitudinal axis of the vehicle 100. This example shows that it is necessary that only a part of the vortex generators 111 have an inclination beta (β) with respect to the longitudinal axis of the vehicle in order to achieve the surprising effects and to reduce the air resistance of the vehicle 100 itself.

In an embodiment not shown, a deflector element may be arranged between the truck and/or between two trailers in order to prevent the air flow between these two vehicle parts. This deflection has a synergistic effect in the system according to the invention, since the air flows through these slots generate lateral turbulences which can have a negative effect on the air flow at the end of the vehicle by limiting the effects of the system according to the invention. Since they generate turbulence on the side body walls of the vehicle due to the lateral air flows, a deflector is arranged between two parts of the ground vehicle, in particular for trucks, buses and trailers, in order to prevent/reduce air flow. This deflector is essentially orthogonal to the direction of movement between the two vehicle parts. Essentially in this case means a variation of more or less 10°.

In a preferred embodiment, the system with the body inclination change and the vortex generators can also be attached to the underside of the vehicle. The vortex generators and the change in inclination are therefore located on the underside of the vehicle.

In another embodiment, air ducts may be arranged at a maximum distance of 250 mm to the change in body inclination.

Finally, it is clear that obvious additions, modifications or variations to the system described above can be made by a person skilled in the art without thereby departing from the scope of protection provided by the appended claims.

### REFERENCE NUMBERS

100 Ground vehicle, truck, trailer
101 Outer side body surface of the ground vehicle
110 Deflector
111 Vortex generators
111a, 111b, 111c Parts of the vortex generators
115 Storage boxes
112 Direction of movement of the ground vehicle
120 Drag Turbulences
121 Reduced turbulences

1. A system for the aerodynamic improvement of a ground vehicle comprising an outer side body surface of the vehicle and a rear surface in the direction of travel being a deflector, with an inclination towards a longitudinal axis of the vehicle and a series of vortex generators placed on surfaces of the deflectors wherein the deflectors are inclined between 5° to 30° with respect to the outer side body surface of the vehicle, and the vortex generators are arranged on an outer surface of the deflectors at a maximum distance of 250 mm from change in body inclination between the outer side body surface of the vehicle and the rear surface of the vehicle, the vortex generators on the outer side body surface of the vehicle or the vortex generators positioned on the rear surface will have an angle β relative to the longitudinal axis of the vehicle between 2° to 50° and the vortex generators protrude between 1 cm to 15 cm from the deflectors.

2. The system for aerodynamic improvement according to claim 1, wherein the outer side body surface and the deflectors are formed by a single body element or are integrated into the vehicle structure.

3. The system for aerodynamic improvement according to claim 1, wherein the outer side body surface and the deflectors are formed by different body elements.

4. The system for aerodynamic improvement according to claim 1, wherein between two vehicles, at least one deflector is arranged to prevent or reduce air flow perpendicular to the direction of movement between the two vehicles.

5. The system for aerodynamic improvement of claim 1 several deflector surfaces form a storage space.

6. The system for aerodynamic improvement according to claim 1, wherein a predetermined breaking point is located between the outer side body surface and the deflector surface.

7. The system for aerodynamic improvement according to claim 1, wherein air ducts are located at a maximum distance of 250 mm from the change in body inclination.

8. The system for aerodynamic improvement according to claim 1, wherein the vortex generators and the body inclination change are located on the underside of the vehicle.

9. An attachment kit for the aerodynamic improvement of a ground vehicle according to claim 1, consisting of connecting elements for connecting the deflector on the rear of the vehicle with a body inclination alpha α between 5° to 30° with respect to the outer side body surface of the vehicle in the direction of a longitudinal axis of the vehicle and on which the vortex generators are arranged at a maximum distance of 250 mm from the change in the body inclination and the vortex generators, or parts of these vortex generators have an angle β to the longitudinal axis of the vehicle between 2° and 50° to the vortex generators protrude between 1 cm to 15 cm from the deflectors.

10. The attachment kit according to claim 9, wherein the connecting elements have a predetermined breaking point.

11. The attachment kit according to claims 9, wherein deflectors consists of flexible material.

12. The attachment kit according to claim 9 wherein at least one deflector is attached between two vehicles, to prevent or reduce air flow between the two vehicles perpendicular to the direction of movement.
